(19) United States
(12) Patent Application Publication
(10) Pub. No.: US 2018/0147603 A1
(43) Pub. Date: May 31, 2018

(54) METHOD OF TREATING NANOPARTICLES

(71) Applicant: Dow Global Technologies LLC, Midland, MI (US)

(72) Inventors: Joseph Renny, Midland, MI (US); Michael A. De Graaf, Middelburg (NL); Mubasher A. Bashir, Terneuzen (NL); Jerome Claracq, Oostakker (BE); Stefan J. Prot, Breskens (NL)

(21) Appl. No.: 15/578,311

(22) PCT Filed: Jun. 21, 2016
(86) PCT No.: PCT/US2016/038464

§ 371 Date: Nov. 30, 2017

Related U.S. Application Data
(60) Provisional application No. 62/193,198, filed on Jul. 16, 2015.

(51) Int. Cl. B05D 3/06; C09D 11/52; C08J 7/06; B05D 1/00; B05D 3/10; B22F 1/00; H01B 1/22; H05B 3/14; H05B 3/26

(52) U.S. Cl. CPC B05D 3/06; C09D 11/52; C08J 7/06; B05D 1/007; B05D 3/107; B22F 9/24; H01B 1/22; H05B 3/141; H05B 3/262; C08J 2367/02; B22F 1/0022

(57) ABSTRACT

The material properties of structures made with conductive nanoparticles are enhanced by radiation sintering followed by chemical sintering. The conductive nanoparticles may be applied to substrates by methods such as screen printing, inkjet, aerosol and electrospinning and then sintering the conductive nanoparticles on the substrates.

### FIELD OF THE INVENTION

The present invention is directed to a method of treating nanoparticles to enhance material properties of structures made with the nanoparticles. More specifically, the present invention is directed to a method of treating nanoparticles to enhance material properties of structures made with the nanoparticles by radiation sintering followed by chemical sintering.

### BACKGROUND OF THE INVENTION

Nanoparticles have properties that are valuable in a variety of applications, such as biology, chemistry, material science, electronics, imaging and medicine. In the electronics industry nanoparticles are typically used as catalysts, such as in electroless metal plating; they are used in the formation of electromagnetic interference (EMI) shielding coatings, radio frequency interference (RFI) shielding coatings, and in the formation of metal mesh for transparent conductive materials (TCM).

Sintering of nanoparticles on substrates has become increasingly important in the development of new materials for printed electronics, additive manufacturing or 3D-printing. Deposition of nanoparticles on substrates can be achieved using a range of techniques: inkjet and aerosol printing, screen printing, electrospinning, extrusion deposition and standard bulk coating methods such as spin or bar-coating. A significant challenge is to achieve efficient sintering of nanoparticles to obtain desired material properties, for example, densification, strength, conductivity and optical properties. Known techniques to sinter metallic nanoparticles are by thermal, photonic or chemical exposure. However, inefficient sintering of nanoparticles may result in compromised and unacceptable material properties of the articles made from the nanoparticles. In addition, excessive sintering, such as with repeated photonic exposure, may damage the substrate on which the nanoparticles are deposited.

When the substrate is sensitive to heat, e.g., polyethylene terephthalate (PET) (T_{g}˜67-81° C.) being able to achieve efficient sintering at low temperatures becomes a requirement. For instance, sintering of metal nanoparticle ink deposited structures may require temperatures exceeding 200° C. for prolonged periods of time which is incompatible with heat sensitive substrates. Accordingly, there is a need for methods to sinter nanoparticles on heat sensitive substrates to enhance the material properties of articles made with nanoparticles and without damaging the substrates.

### SUMMARY OF THE INVENTION

Methods include depositing nanoparticles on a substrate; and treating the conductive nanoparticles on the substrate by radiation sintering followed by chemical sintering to form a sintered structure.

Unexpectedly, the combination of radiation sintering followed by chemical sintering of conductive nanoparticles improves material properties of sintered structures in comparison to many conventional radiation sintering and chemical sintering processes used alone. Excessive sintering of nanoparticles results in sintered structures with unacceptable material properties. Therefore, material properties of sintered structures made by sintering nanoparticles by radiation sintering followed by chemical sintering are not expected to improve but to be, in general, unacceptable. However, the combination of radiation sintering followed by chemical sintering enhances at least the conductivity of the sintered structures often accompanied by increased transmission and decreased haze. The combined sintering methods also enable the use of heat sensitive substrates without concern that the combined sintering methods may cause damage to the substrates or delamination of the sintered structures from the substrates.

The method of radiation sintering followed by chemical sintering may be used in the formation of electromagnetic interference (EMI) shielding coatings, radio frequency interference (RFI) shielding coatings, electrical conductive tracks, formation of metal mesh for transparent conductive materials (TCM), additive manufacturing (3D printing) as well as in any other field where conductive nanoparticles are useful.

### BRIEF DESCRIPTION OF THE DRAWINGS

FIG. 1 is a graph of sheet resistance after photosintering followed by hydrogen chloride exposure [Ohm/sq] vs. sheet resistance after photosintering [Ohm/sq].

FIG. 2 is a graph of haze after photosintering followed by hydrogen chloride exposure [%] vs. haze after photosintering [%].

FIG. 3 is a graph of transmission after photosintering followed by hydrogen chloride exposure [%] vs. transmission after photosintering.

### DETAILED DESCRIPTION OF THE INVENTION

As used throughout the specification, the following abbreviations have the following meaning, unless the context clearly indicates otherwise: ° C.=degrees Centigrade; g=gram; L=liter; mL=milliliter; μL=microliters; rpm=revolutions per minute; msec=milliseconds; D.I.=deionized water; Hz=Hertz; mPa s=millipascal seconds; s=seconds; Mw=weight average molecular weight; Mn=number average molecular weight; m=meters; mm=millimeters; μm=micron=micrometer; cm=centimeter; nm=nanometers; Ω=ohms; Ωm=ohm meters; sq=square; V=volts; kV=kilovolts; mJ=milliJoules; μs=microseconds; UV=ultraviolet; IR=infrared; 3D=three dimensional; SEM=scanning electron micrograph; M=molar; TGA=thermal gravimetric analysis; T_{g}=glass transition temperature; wt %=weight percent; vol %=volume percent; VFR_{core}=volumetric flow rate of the core material; and VFRₛₕₑₗₗ=volumetric flow rate of shell material.

The term “radiation” means energy radiated or transmitted in the form of rays, waves or particles. The term “sintering” means a merging of particles such that the grain boundaries of the particles merge and a mass is formed. The term “mass” means an aggregation of materials. The term “percent (%) transmission”=I/I₀×100 where I₀=intensity of light entering the sample and I=intensity of light exiting the sample. The term “haze” means cloudiness of a material caused by the scattering of light. The formula HCl=hydrogen chloride or hydrochloric acid. The terms “film” and “layer” are used interchangeably throughout the specification. All percent values are weight percent unless otherwise specified. All numerical ranges are inclusive and combinable in any order, except where it is logical that such numerical ranges are constrained to add up to 100%.

Methods include depositing nanoparticles on a substrate; and treating the nanoparticles on the substrate by radiation sintering followed by chemical sintering. Radiation sintering is always performed first with chemical sintering immediately following the radiation sintering. There are no intervening steps between radiation sintering and chemical sintering. Radiation sintering includes photosintering and thermal sintering. Preferably photosintering is used because the photosintering methods of the present invention are more compatible with low temperature substrates than thermal sintering.

A light source for photosintering includes, but is not limited to, a flash lamp such as a xenon arc flash lamp which may have an output ranging from the UV to the IR spectrum. Photosintering may be done using a conventional photon generator apparatus such as the Pulseforge family of tools from Novacentrix or Xenon's SINTERON Pulsed Light systems. Such generators are capable of emitting light over a broad spectrum from UV to short IR. Photosintering may be done with a steady state or pulsed light delivery. A steady state light delivery may be rastered or scanned such that the dwell time in a particular location is short. Short dwell times are preferred because the methods of the present invention are preferably used with low temperature substrates where excess heat may result in damage to the substrate and cause delamination of the deposited nanoparticle structures applied to the substrates. The dwell times may vary depending on the material the substrate is made of and the light delivery apparatus used. Minor experimentation may be done to determine the dwell time with a particular light delivery apparatus.

The photosintering process involves illuminating the conductive nanoparticles with a photon generator such that the nanoparticles absorb the energy. In photosintering energy is transferred to the nanoparticles at ambient temperatures and heat is generated locally. Photosintering causes the nanoparticles to become photochemically excited and as such they dissipate energy via loss of heat which causes them to sinter. Preferably the photon generator is a flash lamp that can deliver large amounts of energy in short time periods. Preferably optical energies applied to the nanoparticles range from 1,000-10,000 mJ/cm², more preferably from 4,000-8,000 mJ/cm². The time periods range preferably from 0.5 s to 1 msec, more preferably from 1 s to 5 s. The output intensity of the lamp may be controlled by the lamp voltage. The duration of the pulse delivery may be controlled through the lamp flash width. Each of these parameters may be independently adjustable within the total power delivery specifications of the power supply connected to the lamp assembly.

Optionally a mask may be applied to the substrate with the nanoparticles prior to photosintering. The mask selectively covers portions of the substrate and leaves other portions uncovered such that upon application of light during photosintering, only those portions of the substrate with the nanoparticles uncovered are sintered.

Thermal sintering differs from photosintering in that the nanoparticles along with the substrate are put in an environment of constant elevated temperatures. Thermal sintering may be done in ovens, infrared sources, heat lamps or other heat delivery systems that transfer heat energy to the nanoparticles and substrate. The thermal sintering temperatures preferably range from 30° to less than 200° C., more preferably from 50° C. to 150° C. Thermal sintering temperatures of the present invention are lower than conventional thermal sintering temperatures to prevent damage to the low temperature substrates. Exposure time of the conductive nanoparticles and substrates to thermal sintering ranges preferably from 30 seconds to 30 minutes, more preferably from 60 seconds to 10 minutes.

After the nanoparticles and the substrate are treated by one of the two radiation sintering methods, the nanoparticles are partially agglomerated. They are then treated by chemical sintering without any intervening processes which may affect the material properties of the nanoparticles or the substrate.

Chemical sintering is done at room temperature by exposing the radiation sintered nanoparticles and substrate to vapors or solutions of halide compounds. Such compounds are sources of chloride, bromide, fluoride and iodide ions. Solvents for solutions of halide compounds include, but are not limited to water, alcohols, ketones and mixtures thereof. Alcohols include, but are not limited to methanol, ethanol, isopropanol and tert-butyl alcohol. Ketones include, but are not limited to acetone. Preferably the solvent is water. Concentrations of halide solutions range from 10 wt % to 60 wt %, preferably from 15 wt % to 50 wt %, more preferably from 20 wt % to 40 wt %. Sources of halide ions include, but are not limited to hydrogen chloride, hydrogen bromide, hydrogen fluoride, hydrogen iodide and halide salts such as alkali metal salts, such as lithium chloride. When the halide source is an alkali metal halide, the solvents for the solution are a mixture of water and organic solvents. Organic solvents include, but are not limited to, glycols, glycol ethers, glycol ether acetates, ketones, esters, aldehydes, alcohols and alkoxylated alcohols. Typically, glycols such as ethylene glycol, diethylene glycol, triethylene glycol, polyethylene glycol, propylene glycol and dipropylene glycol; glycol ethers such as diethylene glycol monomethyl ether, diethylene glycol monopropyl ether, diethylene glycol monobutyl ether and ethylene glycol monomethyl ether; and alcohols such as ethanol, methanol, isopropanol and tert-butyl alcohol.

The substrate with the partially agglomerated conductive nanoparticles may be immersed in the halide solution or exposed to the vapors of the solution. The solutions may be heated to generate fuming halide vapors. Preferably the partially agglomerated conductive nanoparticles are exposed to halide vapors, more preferably they are exposed to fuming halide vapors to complete the sintering method. Chemical sintering typically is done over 1 minute to 24 hours. When the partially agglomerated nanoparticles are chemically sintered by halide vapors, preferably by fuming halide vapors, improvement in conductive and optical properties such as increased transmission and decreased haze occur rapidly over a period of 1 minute to 5 minutes. However, upon storage of the nanoparticles after sintering with the fuming halide vapors, typically, the conductivity of the sintered nanoparticles continues to improve over a 24 hour period.

After the chemical sintering method, the sintered structure or film has fully agglomerated nanoparticles which have a smooth appearance. No further sintering steps are performed. The sintered structure or film may have a low sheet resistivity of 20 Ω/square and less, typically 7-10 Ω/square, high % transmission of 80% and higher, typically 80-90% and low % haze of 12% and less, typically from 2-5%. Sheet resistivity may be measured by conventional methods and apparatus such as a Delcom 737 conductance monitor. Percent transmission and percent haze may also be measured by conventional methods and apparatus such as a Hunterlab Ultrascan VIS instrument.

The conductive nanoparticles may be prepared by various conventional methods known in the art. There is no limitation on the methods envisioned in the preparation of the nanoparticles.

The nanoparticles include conductive materials such as metals, metal oxides and non-metals such as graphite, graphene and carbon black. Preferably the conductive materials used for the nanoparticles are metals. Metals include, but are not limited to silver, gold, platinum, palladium, indium, rubidium, ruthenium, rhodium, osmium, iridium, aluminum, copper, cobalt, nickel, and iron. Preferably the metals are silver, gold, palladium and copper. More preferably, silver, gold and copper are the choice of metals. Most preferably, silver is the choice of metal because it is one of the more thermodynamically stable metals, i.e., corrosion resistant.

The conductive nanoparticles may be stabilized or capped with one or more capping agents to prevent unwanted agglomeration of the nanoparticles. Many conventional polymer capping agents are known in the art and are available or may be made according to processes described in the literature. Preferably, the capping agent is polymethyl methacrylate or random copolymers of methacrylic acid and n-butylmethacrylate. Most preferably, the capping agent is a random copolymer of methacrylic acid and n-butylmethacrylate having hydrophilic and hydrophobic sections along its backbone and having a low Mw of less than 20,000 g/mole, preferably from 1,000-10,000 g/mole, more preferably from 2,000-6,000 g/mole. Typically the conductive nanoparticles are dispersed in water, organic solvent or mixtures of water and organic solvents prior to application to a substrate.

Optional additives which may be included in nanoparticle dispersions tailor the dispersions for specific applications include, but are not limited to buffers, lubricants, humectants, waxes, resins, surfactants, colorants, rheological modifiers, thickeners and adhesion promoters. The additives may be included in the dispersions in conventional amounts known by those of ordinary skill in the art. Preferably, the nanoparticle dispersions exclude such additives.

Substrates used in the method of the present invention may be selected from various known substrates. Preferably the substrates are heat sensitive substrates. Such heat sensitive substrates have a T_{g} ranging from 60° C. to 170° C., preferably from 60° C. to 100° C. Preferably, the substrate is a transparent substrate selected from various known transparent substrates, including: both transparent conductive and transparent nonconductive substrates. Preferably, the transparent substrate is selected from the group consisting of polyethylene terephthalate (PET), polycarbonate (PC), polymethyl methacrylate (PMMA); polyethylene naphthalate (PEN), polyethersulfone (PES), cyclic olefin polymer (COP), triacetylcellulose (TAC), polyvinyl alcohol (PVA), polyimide (PI), polystyrene (PS)(e.g., biaxially stretched polystyrene) and glass (e.g., Gorilla® glass and Willow® glass both available from Dow Corning). More preferably, the transparent substrate is selected from the group consisting of glass, polyethylene terephthalate, polycarbonate and polymethyl methacrylate. Most preferably, the transparent substrate is polyethylene terephthalate.

Inkjet printing may be a continuous inkjet method or a drop-on-demand method. The continuous method is a printing method where the direction of the ink is adjusted by changing an electromagnetic field while continuously jetting the ink using a pump. The drop-on-demand is a method which dispenses the ink only when needed on an electronic signal. Drop-on-demand may be divided into a piezoelectric inkjet method where pressure is generated by using a piezoelectric plate causing a mechanical change by electricity and a thermal ink jet method using pressures which are generated by the expansion of bubbles produced by heat. Conventional parameters for ink jetting ink nanoparticle dispersions are well known in the art and may be used to inkjet the ink nanoparticle dispersions of the present invention; however, specific settings of the ink jetting parameters for a particular dispersion may vary and minor experimentation may be involved to achieve the desired ink jetting performance for a particular nanoparticle dispersion.

In contrast to the inkjet printing method, the aerosol method first forms an aerosol of the ink. The aerosol is guided to the substrate via a pressurized nozzle with the pressurized nozzle being mounted to a print head. The aerosol is mixed with a focusing gas and is transported to the pressurized nozzle in a focused form. The use of focusing gas to dispense the ink reduces the probability of clogging the nozzles and also enables the formation of finer deposit and a greater aspect ratio than with an inkjet apparatus. Conventional aerosol parameters may be used to apply the nanoparticle dispersions; however, minor experimentation may be involved to achieve the desired performance.

Electrospinning such as coaxial electrospinning may be used to deposit the nanoparticle dispersions on a substrate. In general, coaxial electrospinning includes feeding the ink core component which includes the nanoparticles dispersed in water, organic solvent or mixtures thereof and a shell consisting of a mixture of a polymer solution in water an organic solvent or a mixture of the two through a coannular nozzle having a central opening and a surrounding annular opening where the ink core component is fed through the central opening and the shell is fed through the surrounding annular opening. Preferably, the ratio of the volumetric flow rate of the shell material, VFRₛₕₑₗₗ, fed through the surrounding annular opening to the volumetric flow rate of the core material, VFR_{core}, fed through the central opening is greater than or equal to the ratio of the cross sectional area of the surrounding annular opening perpendicular to the direction of flow, CSAₐₙₙᵤₗₐᵣ, to the cross sectional area of the central opening perpendicular to the direction of flow, CSA_{center}. More preferably the following expression is satisfied by the processing conditions: VFRₛₕₑₗₗ/VFR_{core}≥1.2*(CSAₐₙₙᵤₗₐᵣ/CSA_{center}). As with inkjet and aerosol applications coaxial electrospinning parameters may be conventional and minor experimentation may be involved to achieve the desired performance. An example of such a process is disclosed in U.S. 2014/0131078.

The following examples are included to further illustrate the invention but are not intended to limit its scope.

### Example 1

### Synthesis of Nanoparticles

Silver nanoparticles and inks were prepared as follows. First, 23.6 g of capping solution 20 wt % methacrylic acid/n-butylmethacrylate random copolymer with hydrophilic and hydrophobic segments with 47 mole % moieties from methacrylic acid and 53 mole % moieties from n-butylmethacrylate in water/propylene glycol mixture (10:90 wt/wt) was placed in a reaction flask, and 315 g of diethanolamine, 114 g of propylene glycol and additional 20 g D.I. water was added to the flask. The weight average molecular weight of the random copolymer was 4000 g/moles as determined by gel permeation chromatography (GPC) relative to polystyrene calibration. The mixture was stirred at a rate of 500 rpm for 1 hour to obtain a clear solution. The pH of the solution was approximately 8. Freshly prepared silver nitrate solution (67 mL of 50 wt % solution in D.I. water) was then quickly added to the reaction mixture under vigorous stirring (stirring rate of 1000 rpm) at room temperature. A brownish precipitate was formed upon addition of the silver nitrate solution, which re-dissolved instantaneously. The temperature of reaction mixture was then raised to 75° C. within 15 minutes and allowed to react for 3 hours. At the end of the reaction, the mixture had turned dark brown in color indicating high concentrations of silver nanoparticles.

The reaction mixture was allowed to cool down and 500 mL of acetone was added to facilitate the precipitation of solid material from solution. The supernatant was decanted and the paste in the bottom of flask was re-dispersed in 800 mL water/1-propoxy-2-propanol (75/25 wt/wt) and centrifuged at 10000 rpm for 1 hour. The solid cake resulted from centrifugation was dried in ambient conditions to obtain about 50 g of nanoparticle material. The purity of this material was greater than 98 wt % silver as determined by TGA (heating up to 600° C. under air). The particle size of the particles was measured by SEM image analysis using multiple images. The average size was found to be 56 nm.

### Example 2

### Preparation of Nanoparticle Dispersion

45 g of dried nanoparticles (>98 wt % silver purity) were taken in ball mill jar (35 mL) and 18 g of dispersing solvent (water/1-propoxy-2-propanol/tert-butanol 35/15/50 by weight mixture) was added. The mixture was ball milled at 15 Hz for 3 hours. This treatment resulted in about 25 mL of 70 wt % silver nanoparticle ink having viscosity of about 30 mPa s as measured by RS600 rheometer from ThermoFisher. The rheometer had parallel fixtures with 25 mm diameter and 1 mm gap height. Measurements were performed at 20° C.

### Example 3

Coaxial Electrospinning of Nanoparticle Dispersion on Transparent Substrates

An electrospinning machine (Model EC-DIG from IME Technologies) equipped with a single coaxial nozzle was used to electrospin the silver nanoparticle dispersion of Example 2 as the core component and a shell component of polyethylene oxide (Mn=400 kg/mole) 5.25 wt % in isopropanol and water mixture of 65:35 wt/wt. The nozzle used was a coaxial nozzle (EM-CAX from IME Technologies) having an inner opening having a circular cross section perpendicular to the direction of material flow having a 0.4 mm diameter; and an outer opening having an annular cross section perpendicular to the direction of material flow and concentric with the inner opening; and having a 0.6 mm inner diameter and a 1.2 mm outer diameter. When spinning material, the core component was fed through the inner opening of the coaxial nozzle and the shell component was fed through the outer opening of the coaxial nozzle. The core and the shell components were fed through the coaxial nozzle using independent syringe pumps (EP-NE1 from IME Technologies) controlling the volumetric flow rate of the core component, VFR_{core} and the volumetric flow rate of the shell component, VFRₛₕₑₗₗ such that the flow rate ratio of the VFRₛₕₑₗₗ/VFR_{core} was 10:1. The electrospinning process was performed at ambient atmospheric conditions in a climate controlled laboratory at 20° C. and relative humidity of 25-35%.

The substrate was 188 μm thick×12.7 cm wide×30.5 cm long transparent, flexible, HP 52 polyethylene terephthalate (PET) film available from Hewlett-Packard. The substrate was wrapped around the rotary drum of a Module EM-RDC rotating drum collector from IME Technologies.

The remaining parameters for the spinning operation were as follows: the distance between the rotating substrate and the needle was set at 11 cm; the nozzle was set at 5 kV; the plate beneath the substrate was set at −0.2 kV; the drum rotation rate on the rotating drum collector (y axis) was set at 500-1000 rpm; the needle scan speed (x axis) was set at 5 mm/second; the needle scan distance was set at 12 cm; and the total spinning time was set at 4 minutes. Silver nanoparticle metal meshes were formed on the PET substrates. The diameters of the nanoparticle wire meshes on the substrates were around 5 μm±1 μm.

### Example 4

### Photosintering the Lines of Silver Nanoparticle Coated PET Films

Sample films of 5 cm×2.5 cm were cut from the substrate on which lines of silver nanoparticles were deposited via coaxial electrospinning according to Example 3. The samples were then fed through a Pulseforge 3100 photon generator from Novacentrix on a conveyor belt at a rate of 7 m/minute. The photon generator was set at 200 V to produce 2000 s pulses at 3 Hz frequency on continuous mode generating optical energies of 6076 mJ/cm². The samples exiting the photon generator were metal mesh transparent conductors.

The sheet resistance of the silver mesh samples was measured with a Delcom 737 conductance monitor and the % transmission and the % haze were measured on a Hunterlab Ultrascan VIS instrument. The results are shown in the table below.

TABLE 1

| | Sheet Resistance | % | % |
|---|---|---|---|
| Sample | (Ω/square) | Transmission | Haze |
| 1 | 15.5 | 80.9 | 12.2 |
| 2 | 227 | 88.8 | 2.4 |
| 3 | 44.8 | 86.1 | 5.8 |
| 4 | 47 | 86.4 | 5.6 |
| 5 | 15 | 84.9 | 8.9 |

### Example 5

### Photosintering and Chemical Sintering the Lines of Silver Nanoparticle Coated PET Films

The silver mesh samples from Example 4 were then chemically sintered under a fume hood by exposing them for one minute to hydrogen chloride vapor from a beaker containing 37% aqueous hydrogen chloride. The sheet resistance, % transmission and % haze were measured after 24 hours. The results are in Table 2.

TABLE 2

| | Sheet Resistance | % | % |
|---|---|---|---|
| Sample | (Ω/square) | Transmission | Haze |
| 1 | 8 | 82.9 | 11.3 |
| 2 | 75 | 88.9 | 2.4 |
| 3 | 19 | 86.7 | 5.3 |
| 4 | 20 | 87.9 | 3.8 |
| 5 | 7.8 | 89.0 | 6.6 |

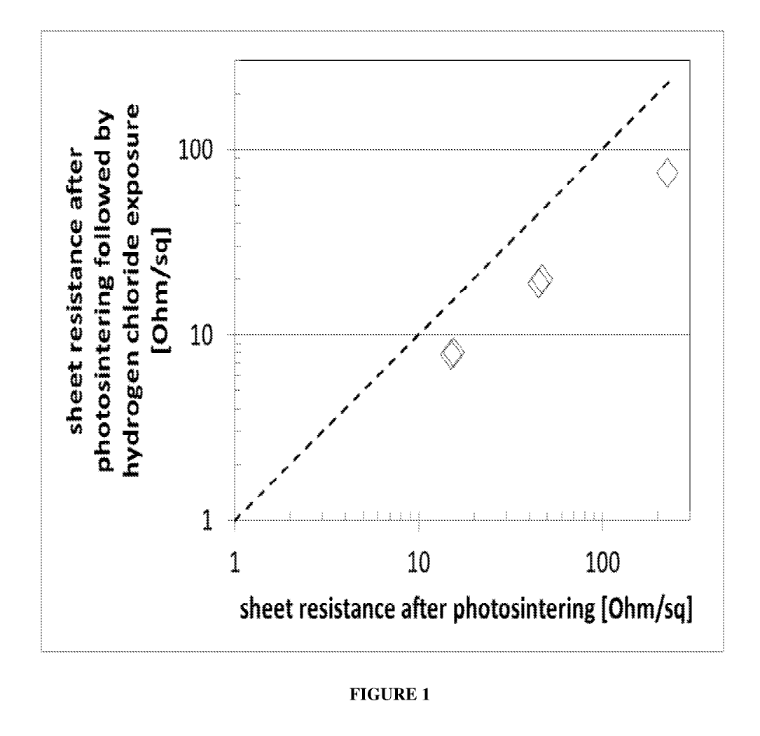

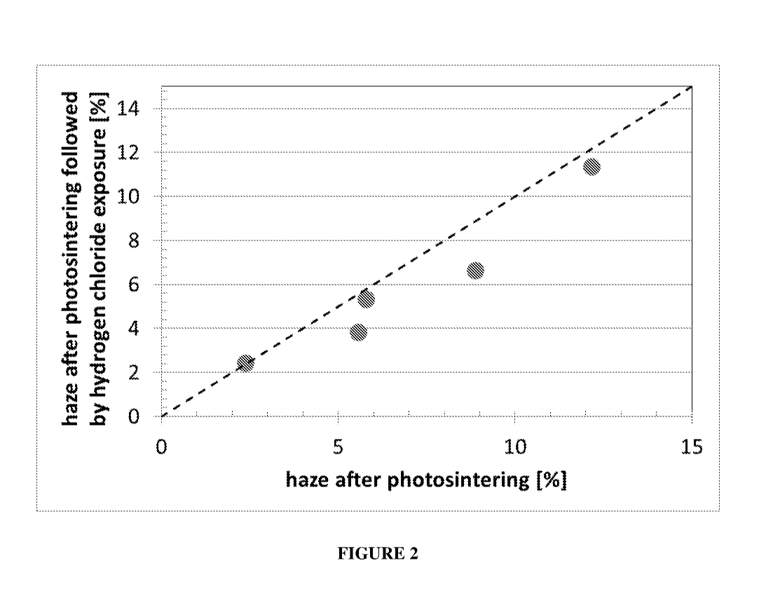

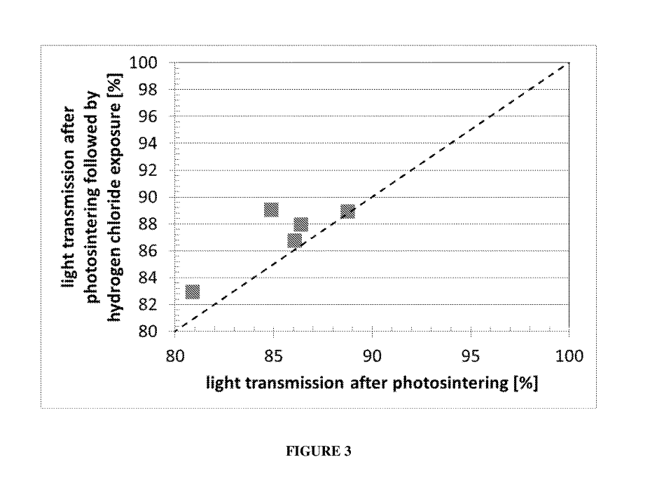

The values for each parameter for the photosintered and the photosintered followed by chemical sintering with hydrogen chloride vapor were plotted in FIGS. 1-3.

As shown in the tables above and in FIG. 1 the samples which were treated by photosintering followed by chemical sintering with hydrogen chloride had reduced sheet resistance in contrast to just photosintering. With the exception of sample 2 where the % haze for photosintering and photosintering followed by chemical sintering were the same, the % haze was reduced when the samples were treated by both sintering methods. The % transmission showed some increase by using both sintering methods. The most notable results were observed in the decrease in the sheet resistance after the samples were both photosintered and then chemical sintered, thus increasing the conductivity of the samples.

### Example 6

### Chemical Sintering of the Lines of Silver Nanoparticle Coated PET Films

The silver nanoparticles and silver nanoparticle dispersions were prepared as described above. The silver nanoparticle dispersions were applied to the PET films by coaxial electrospinning as described above in Example 3. The silver line samples were treated as shown in the table below.

TABLE 3

| | Sheet Resistance | | |
|---|---|---|---|
| | (Ω/square) After | % | % |
| Sintering | 17 Hours | Haze | Transmission |
| None | Infinite | 9.2 | 78.73 |
| HCl Vapor | 16 | 9.3 | 77.65 |
| Dipping in HCl | 25 | 4.5 | 79.75 |
| (1M, aqueous) | | | |
| Dipping in LiCl | 6900 | 10.9 | 77.9 |
| (2 wt % isopropyl | | | |
| alcohol and water | | | |
| Dipping in LiCl | Infinite | 10.6 | 77.16 |
| (2 wt % aqueous) | | | |

The HCl vapor and HCl dipping experiments resulted in samples with comparable sheet resistance to those described in Tables 1 and 2; however, it must be noted that the chemically treated only samples contained a larger amount of deposited nanoparticles, as indicated by their lower transmission. The consequence of this is that the final sheet resistance of the material is expected to have a lower theoretical minimum upon sintering.

The sintering method of Example 5, Table 2, where the samples were sintered by first photosintering then followed by chemical sintering showed improved % haze over all of the samples treated chemically in Table 3 except Example 1 of Table 2 which had a % haze=11.3. Sheet resistance for the samples treated by photosintering followed by chemical sintering with HCl vapor in samples 1 and 5 of Table 2 in Example 5 measured 1 hour after the chemical sintering were much lower than the sheet resistance of the samples treated only chemically, thus these two samples had higher conductivity than those samples that were just chemically sintered. Samples 2-4 of Table 2 in Example 5 had lower sheet resistance than the nanoparticles chemically sintered by dipping in LiCl solution whether the solution was 2 wt % isopropyl alcohol or 2 wt % water, thus having higher conductivity than the nanoparticles chemically sintered only with solutions of LiCl.

What is claimed is:

1. A method comprising:
a) depositing conductive nanoparticles on a substrate; and
b) treating the conductive nanoparticles on the substrate by radiation sintering followed by chemical sintering to form a sintered structure.

2. The method of claim 1, wherein the radiation sintering is chosen from photosintering and thermal sintering.

3. The method of claim 2, wherein the radiation sintering is photosintering.

4. The method of claim 1, wherein the chemical sintering is done by halide vapor or by a halide solution.

5. The method of claim 1, wherein the nanoparticles are deposited on the substrate by electrospinning, inkjet, aerosol, gravure printing or screen printing.

6. The method of claim 1, wherein the substrate is selected from polyethylene terephthalate, polycarbonate, polymethyl methacrylate, polyethylene naphthalate, polyethersulfone, cyclic olefin polymer, triacetylcellulose, polyvinyl alcohol, polyimide, polystyrene and glass.

7. The method of claim 6, wherein the T_{g} of the substrate ranges from 60° C. to 170° C.

8. The method of claim 1, wherein the nanoparticles comprise metals, metal oxides, conductive non-metals or mixtures thereof.

9. The method of claim 8, wherein the metals are chosen from silver, gold, platinum, palladium, indium, rubidium, ruthenium, rhodium, osmium, iridium, aluminum, copper, cobalt, nickel, and iron.
